(19) United States
(12) Patent Application Publication
(10) Pub. No.: US 2007/0056948 A1
(43) Pub. Date: Mar. 15, 2007

(54) System and Method for Preventing Growth of Mold or Mildew in a Building

(76) Inventor: Bruce Hall, Apopka, FL (US)

Correspondence Address: Robert L. Wolter;Beusse Brownlee Wolter Mora & Maire, P.A., Suite 2500, 390 North Orange Avenue, Orlando, FL, 32801, US

(21) Appl. No.: 11/531,373

(22) Filed: Sep. 13, 2006

Related U.S. Application Data
(63) Continuation-in-part of application No. 10/926,242, filed on Aug. 25, 2004.
(60) Provisional application No. 60/498,206, filed on Aug. 26, 2003.

(51) Int. Cl. H05B 3/00; H05B 1/00; H05B 11/00

(52) U.S. Cl. 219/213

(57) ABSTRACT

A system for preventing growth of mold and mildew in buildings comprises an air diffusion device covering an opening of a heating ventilation and air conditioning duct. A heating cable is affixed to a flange of the air diffusion device that extends along a periphery of a screen covering the opening. The cable is activated to heat the surfaces of the air diffusion device to a temperature above dew point and prevent condensation.

This application is a continuation-in-part of the co-pending patent application Ser. No. 10/926,242 filed Aug. 25, 2004, filed as provisional patent Application No. 60/498,206 on Aug. 26, 2003, and to which priority is claimed.

### BACKGROUND OF THE INVENTION

This invention pertains, generally, to heating ventilation and air conditioning systems. More specifically, the invention pertains to those problems associated with the growth of mold and mildew on or around such systems when operating in the cooling or refrigeration mode.

Mold and mildew growth in buildings is a serious problem. In particular, areas in close proximity to large bodies of water, and/or areas having high or consistent humidity, experience problems with the growth of mold and mildew in buildings. Condensation forms on surfaces, for example heating ventilation and/or air conditioning vents in buildings, which are below dew point temperature and are exposed to warm, humid air. These surfaces may contain dust or dirt, which is a food source for the growth mold and mildew.

Common mold and mildew grows in temperatures ranging from about forty degrees to one hundred twenty degrees Fahrenheit, which includes the typical environment in which people live. When condensation forms on an interior surface of a building an environment is created for the growth of mold or mildew. Mold growth is typically eliminated by removal of fungi spores, which is performed by sophisticated HVAC filtration systems. However, a need exists for an inexpensive system and method for controlling the growth of mold and mildew.

### SUMMARY OF THE INVENTION

The invention for the system for preventing the growth of mold or mildew comprises an air diffusion device for covering an opening in a wall and/or at the end of a ventilation duct. The air diffusion device has at least one flange extending along at least a portion of a screen on the air diffusion device that covers the opening. At least one heating cable is affixed to the flange. When the heating cable is activated it raises the surface temperature of the flange and/or other parts of the air diffusion device above a dew point preventing condensation from forming on or near the air diffusion device. The term “dew point” is the temperature at which water vapor condenses onto a surface.

### BRIEF DESCRIPTION OF THE DRAWINGS

FIG. 1 is a sectional view of an air diffusion device with a heating cable affixed thereto.

FIG. 2 is a front elevational view of an air diffusion device.

FIG. 3 is an embodiment of the invention with the heating cable electrically linked to thermostat.

### DETAILED DESCRIPTION OF THE INVENTION

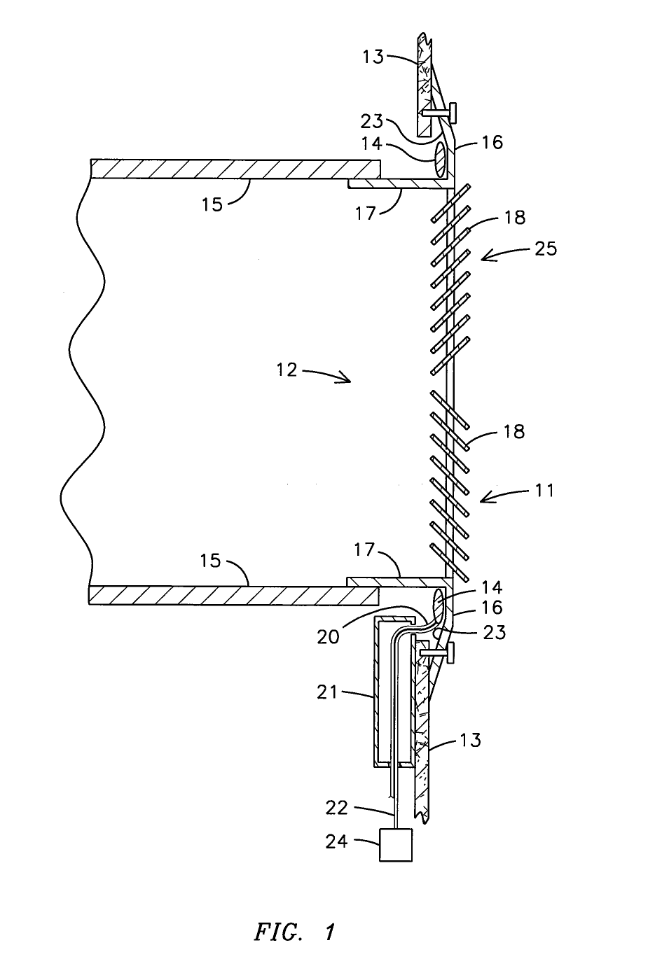

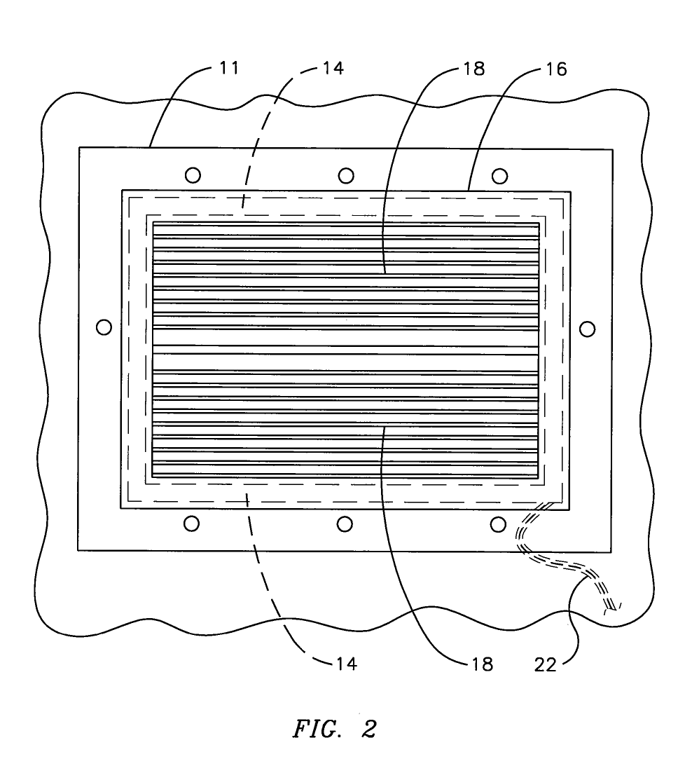

The system 10 is shown in the sectional view illustrated in FIG. 1 and a front elevational view illustrated in FIG. 2. The system generally includes a heating cable 14 applied to a surface of an air diffusion device 11 that is used with a heating ventilation air conditioning system for a building. In the embodiment shown in FIG. 1, a vent is shown as including an opening 12 in a wall 13 and an air duct 15, with an air diffusion device 11 mounted on the wall 13 over the opening 12. The invention is not limited to an air diffusion device 11 mounted over an opening 12 in a wall, but may include an air diffusion device 11 that is mounted to an end of a duct that is for example not contained within a wall system.

The air diffusion device 11 includes a screen 25 that covers the opening 12. The term screen as used in this disclosure includes a covering that has openings through which air may pass, and may include a perforated metal covering. In the embodiment shown in FIGS. 1 and 2, the screen 25 includes a plurality of vanes 18 that cover opening 12. The opening 12 is in fluid communication with the duct 15 for discharge of air into a room of the building.

The air diffusion device 11 includes at least one flange that extends along at least a portion of a periphery of the screen 25 or vanes 18. The air diffusion device 11 shown in FIG. 1 includes a first flange 16 for fastening the air diffusion device 11 to the wall 13. A second flange 17, extending along a periphery of the vanes 18, extends substantially perpendicular to a vertical disposition of the air diffusion device 11 and into the opening 12 of the wall 13 for alignment of the vanes 18 with respect to the opening 12 and duct 15.

In the embodiment shown in FIG. 1, the heating cable 14 is affixed to a back surface 23 of the first flange 16. As shown in FIG. 2, the heating cable 14 preferably extends around a periphery of the vanes 18. The heating cable 24 may also be applied to the second flange 17. The heating cable 14 may be affixed to the flange 16 using known mechanical fasteners. For example, clips (not shown) may be operatively connected to the flanges 16 and 17 for attachment of the cable 14. Alternatively, an adhesive may be applied to the cable or surface of the flanges 16 or 17 for attachment of the cable 14. Depending on building code requirements and the cable 14 voltage, the cable may have to be contained within a conduit.

The heating cable 14 may be a standard heating cable that is used for heating pipes and having a voltage rating ranging from about 120 volts to about 240 volts AC power. Such heating cables are available at known wholesale distributors and building/home supply stores, such as, W. W. Grainger, Johnstone Supply, Home Depot or Lowe's. Lower voltage heating cables, i.e., 24 volts AC or DC power, may be desirable because such a lower voltage cable typically is not required to be contained within a conduit.

The heating cables 14 typically include electrical leads 20 that are connected to a junction box 21 mounted on an interior of the building wall 13. A power cable 22 is connected from the power junction box 21 to a power source 24 for the activation of the heating cable 14. The size of the heating cable 14 will depend, in part, on the size of the air diffusion device 11, and the amount of surface area to be heated. The heating cable 14 selected should be such that it raises the surface temperature of the air diffusion device 11 to a temperature exceeding dew point temperature.

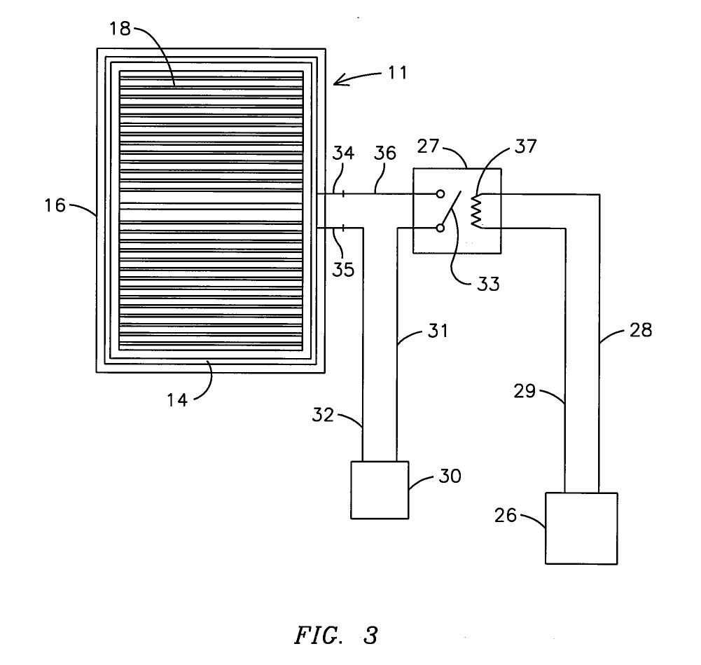

With respect to FIG. 3, an embodiment is illustrated whereby the heating cable 14 is affixed to the air diffusion device 11 and is electrically linked to a thermostat 26. The FIG. 3 illustrates a rear elevational view of the air diffusion device 11 with a heating cable 14 affixed to a flange 16 that extends around the vanes 18. The heating cable 14 includes wire leads 34 and 35 to connect the heating cable 22 to a power source 30 such as a 120 V AC volt power source typically available in homes throughout in the United States.

The thermostat 26 can be any available mechanical or digital thermostat that is used to control room temperature and/or the activation of an air conditioning and/or heating unit. The thermostat 26 may be programmed to activate the cooling or refrigeration function of an air conditioning unit when the room temperature exceeds a predetermined temperature. Lead wires 28 and 29 are connected to the thermostat 26 so that an electrical signal, such as a 24 V DC signal, is sent from the thermostat 26 to coil 37 of a relay 27 to remotely activate the heating cable 14.

When power is supplied to the coil 37, in the relay 27, via lead wires 28 and 29, a switch 33 in the relay 27 is actuated to connect the power supply 30 to the heating cable 14. Power is supplied to the heating cable 14 via wires 31 and 36. The line 32 may include a neutral wire or line to of a typical 120 V AC power supply and line 31 may include a hot wire or line that is switched by the relay 27 to selectively connect and disconnect the heating cable 14 to the power supply 30. In an example embodiment, the relay 27 may be configured for normally off operation so that the heating cable 14 is disconnected from the power supply 30 when the coil 37 is not energized. The relay 27 may be capable of being energized by a 24 Volt DC current and capable of handling switching voltage from about 100 VAC to about 250 VAC. In addition, the switch 33 of the relay 27 may be capable of handling a current sufficient to power one or more heating cables 14 including a code specified safety margin.

In this manner, the heating cable 22 is activated when the thermostat 26 is used to manually or automatically activate the cooling or refrigeration function of an air conditioning system, so the heating cable 22 is on and heating the air diffusion device 11 only when the cooling or refrigeration function of an air conditioning unit is activated. The heating cable is not activated when a heating unit (not shown) is activated.

The practice of the method includes the step of applying the heating cable 14 to the surface of the air diffusion device 11. The heating cable 14 is then activated to elevate a temperature surface of the air diffusion device 11. In an embodiment described above, the heating cable 14 is activated whenever the cooling or refrigeration function of the air conditioning unit is turned on. In doing so, the surface temperature of the diffuser is raised to a point exceeding dew point temperature. An additional benefit is that the air discharged from the HVAC system is further dried. When warm or hot, humid and wet air is allowed into the room the moisture in the room air will not condense on, at, or near the air diffusion device, which would otherwise create an environment for the growth of mildew or mold.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

I claim as my invention:

1. A system for preventing growth of mold and mildew in a building or air conditioning system for a building, comprising:
a. at least one air diffusion device covering an opening of a duct of a heating ventilation and air conditioning system of a building through which conditioned air is discharged, and the air diffusion device having a screen covering the opening and a flange extending along at least a portion of the periphery of the screen; and,
b. at least one electric heating cable affixed to a surface of the flange of the air diffusion device and surrounding at least a portion of the screen for heating the air diffusion device to a temperature above a dew point of ambient air in the building, and the heating cable is activated whenever the cooling or refrigeration function of an air conditioning unit, of the heating, ventilation and air conditioning system, is activated.

2. The system of claim 1 wherein the heating ventilation and air conditioning system includes a thermostat that is program to activate the air conditioning unit when a room temperature exceeds a predetermined temperature, and the heating cable is electrically connected to the thermostat so the heating cable is activated whenever the thermostat generates a signal to activate the cooling or refrigeration function of the air conditioning unit.

3. The system of claim 2 further comprising at least one relay electrically disposed between and connected to the heating cable and the thermostat to remotely activate the heating cable whenever the thermostat generates a signal to activate the cooling or refrigeration function of the air conditioning unit.

4. The system of claim 1 wherein the air diffusion device is mounted on a wall having an opening in fluid communication with the duct.

5. The system of claim 4 wherein the air diffusion device includes a first flange fastened to the wall and a second flange disposed substantially perpendicular to the first flange for alignment of the air diffusion device where the duct and the heating cable is capable of being attached to either the first flange or second flange.

6. A method for preventing the growth of mold or mildew in a building, comprising the steps of:
a. mounting at least one air diffusion device over an opening of a duct of a heating, ventilation and air conditioning system of a building; and,
b. elevating a temperature of a surface of the air diffusion device above a predetermined dew point temperature of ambient air in the building whenever the cooling or refrigeration function of an air conditioning unit, of the heating, ventilation and air conditioning system, is activated.

7. The method of claim 6 wherein the heating, ventilation and air conditioning system includes a thermostat that is to activate an air conditioning unit, of the heating, ventilation and air conditioning system, when a room temperature exceeds a predetermined temperature, the method comprises the step of electrically connecting to the heating cable to the thermostat so the heating cable is activated whenever the thermostat generates a signal to activate the cooling or refrigeration function of the air conditioning unit.

8. The method of claim 6 wherein in the temperature elevating step comprises applying an electrical heat source to a surface of the air diffusion device.

9. The method of claim 6 wherein the step of elevating the temperature includes applying an electric heating cable to a surface of the air diffusion device and activating the heating cable with an electrical current to increase a temperature of the surface of the air diffusion device.

10. The method of claim 6 wherein the step of elevating the temperature includes elevating the temperature of one or more surfaces of the air diffusion device above the dew point temperature of the surrounding environment.
